(19) United States
(12) Patent Application Publication
(10) Pub. No.: US 2008/0232369 A1
(43) Pub. Date: Sep. 25, 2008

(54) MAPPING MECHANISM FOR ACCESS NETWORK SEGREGATION

(75) Inventors: Philippe Belanger, Laval (CA); Jacques (Jim) Dumont, Dollard-des-Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/690,555

(22) Filed: Mar. 23, 2007

(51) Int. Cl. H04L 12/56

(52) U.S. Cl. 370/392

(57) ABSTRACT

Communication nodes, systems and methods are described which provide an association between messaging and access resource and admission control functions (A-RACFs) within an IP addressing zone. The association can be communicated within messages using, for example, a topology zone identifier.

### TECHNICAL FIELD

The present invention generally relates to communication systems and methods and, more particularly, to mapping mechanisms and techniques for segregating access networks in communication systems.

### BACKGROUND

Communication systems continue to grow and evolve. Convergence between different types of communication systems, e.g., Internet Protocol (IP), connection-based voice communications, and the like, is advancing rapidly. Recently the phrase “Next Generation Network” (NGN) has been used to describe various activities associated with this evolution. As defined by the International Telecommunications Union (ITU), an NGN is a packet-based network able to provide services (including telecommunication services) and able to make use of multiple broadband, QoS-enabled transport technologies and in which service-related functions are independent from underlying transport-related technologies. NGNs will also likely offer unrestricted access by users to different service providers and will support generalized mobility, which in turn will provide for consistent service provision to end users.

Various standardization groups are working on reaching a consensus regarding the technology considerations which will affect NGN design and implementation. For example, Telecoms & Internet converged Services & Protocols for Advanced Networks (TISPAN) is an ETSI standardization group which focuses on convergence of technologies used in the Internet and other fixed networks. Among other things, TISPAN seeks to provide a modular, subsystem-oriented architecture which facilitates the addition of new subsystems over time to cover new demands and service classes. The TISPAN architecture attempts to ensure that network resources, applications, and user equipment are common to all of the various subsystems to provide for enhanced mobility across, for example, administrative boundaries.

One of the TISPAN subsystems is referred to as the Network Attachment Sub System (NASS). The NASS is responsible for, among other things, handling configuration information, user authentication data, IP address allocation and registering associations between IP addresses allocated to user equipment (UE) and related network location information. These latter two NASS functions, i.e., allocating IP addresses and registering associations, are handled by the Network Access Configuration Function (NACF) and the Connectivity Session Location and Repository Function (CLF), respectively, which are functional entities that are also specified by the NASS portion of the TISPAN standards.

These NASS functional entities interact with another TISPAN subsystem known as the Resource Admission Control Subsystem (RACS) and, of particular interest for the present discussion, with the Access Resource and Admission Control Function (A-RACF) functional entity of the RACS. The A-RACF functional entity, among other things, receives information about the IP address allocated to a particular user and maps that IP allocation to physical resources in the access network. Each A-RACF is, in these exemplary embodiments, associated with a Session Border Controller (SBC). An SBC interacts directly with the network elements that provide communication services to an end user, e.g., Digital Subscriber Line Access Multiplexers (DSLAMs).

An exemplary, conceptual relationship between these NASS functional entities and the RACS functional entities and SBCs is provided as FIG. 1(a). Therein, two IP addressing zones (also sometimes referred to as IP addressing realms or simply “realms”, all of which terms and phrases are used interchangeably in this specification) A and B are shown. Within each IP addressing zone, a particular IP address is unique. Thus, as illustrated in FIG. 1(a), a unique IP address is associated with “x.y.z@ery.ca” in IP addressing zone A and a unique IP address is associated with “x.y.z@ery.us” in IP addressing zone B. As illustrated, each IP addressing zone may have multiple A-RACFs 14 and corresponding SBCs 16 associated therewith. The NASS functional entities NACF 10 and CLF 12 may support multiple IP addressing zones, as shown.

The NASS and TISPAN standards employ a Global IP Address technique for allowing IP address reuse via multiple domains. The interface specified for communication between the CLF 12 and A-RACFs 14, referred to in these standards as the “e4” interface, contains the Global IP Address as a parameter. For example, when performing an access profile push (e.g., when an IP address has been allocated to a user), the CLF 12 sends a message containing the information elements shown in FIG. 1(b), which includes a “Globally Unique IP Address” information element. Similarly, as shown in FIG. 1(c), when performing an access profile pull, e.g., in response to a recovery operation, an A-RACF 14 also provides a “Globally Unique IP Address”. These “Globally Unique IP Address” information elements include, as shown in FIGS. 1(b) and 1(c), the IP address of the user equipment associated with the user for which profile information is being pushed or pulled and the addressing domain in which the IP address is significant. For more information regarding the acronyms and other terms in the tables of FIGS. 1(b) and 1(c), the interested reader is referred to the standards document “Telecommunications and Converged Services and Protocols for Advanced Networks (TISPAN); Network Attachment Sub-System (NASS); e4 interface based on the DIAMETER protocol”, promulgated by ETSI as ETSI ES 283 034 V1.1.1 (06-2006).

One problem associated with this standardized approach to IP address handling is that it presumes that there is a one-to-one relationship between IP addressing zones or realms and the A-RACF servers. Thus there is no information in the “Globally Unique IP Address” information element which would, for example, inform a CLF 12 which one of a number of different A-RACFs 20 within a single IP Addressing zone should receive information associated with a particular profile push or pull, which problem is conceptually illustrated as FIG. 1(d). One solution to this problem is to limit implementations to require that each A-RACF server be associated with its own IP Addressing zone, however this solution may require the maintenance of a large number of realm instances across the network and reduces deployment flexibility between NASS and RACS entities. Additionally, there may be further problems associated with network implementations wherein the A-RACF servers each correspond to an IP addressing zone in the context of network performance.

Accordingly, it would be desirable to have a mechanism for segregating access networks which avoids the afore-described problems and drawbacks.

### SUMMARY

According to an exemplary embodiment, a network node includes a processor for transmitting and receiving messages associated with at least one of: a location of user equipment and an IP address allocation to the user equipment, wherein the messages are associated with one of a plurality of access resource and admission control functions (A-RACFs) within an IP addressing zone based upon an identifier, and wherein the one of said plurality of A-RACFs is associated with the user equipment.

According to another exemplary embodiment, a method for communicating in a network includes the steps of transmitting messages associated with at least one of: a location of user equipment and an IP address allocation for the user equipment, wherein the messages are associated with one of a plurality of access resource and admission control functions (A-RACFs) within an IP addressing zone based upon an identifier, and wherein the one of the plurality of A-RACFs is associated with the user equipment.

According to yet another exemplary embodiment, a communication network includes a first server which provides a connectivity session location function (CLF) to register an association between an IP address allocated to a user equipment and network location information, and a plurality of second servers, each of which provides an access resource and admission control function (A-RACF) to verify that bandwidth needed for requested services can be delivered, the plurality of second servers each being associated with a single IP addressing zone, wherein each of the second servers is associated with a different topology zone identifier and further wherein at least some messages transmitted between the first server and the second servers includes both a global IP address information element and one of the topology zone identifiers.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1(a) illustrates an exemplary relationship between entities associated with two IP addressing zones;

FIGS. 1(b) and 1(c) depict conventional access profile push and pull messages, respectively;

FIG. 1(d) illustrates a problem associated with a lack of cardinality between CLF and A-RACF entities;

FIG. 2 depicts a communication network according to an exemplary embodiment;

FIG. 3 is a flowchart illustrating a method of communicating within a network according to an exemplary embodiment; and

FIG. 4 is a network node according to an exemplary embodiment.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

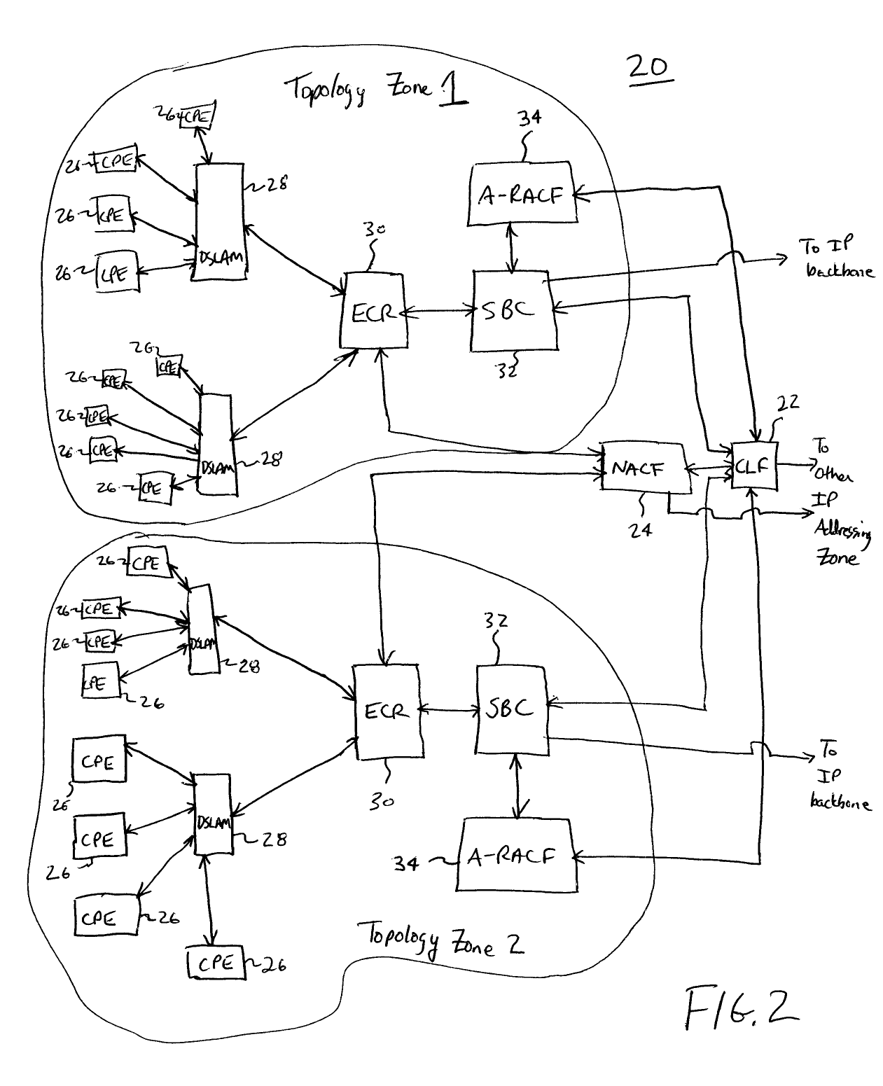

In order to provide some context within which exemplary embodiments will be better understood, consider the exemplary portion of a communication network illustrated as FIG. 2. It will be appreciated by those skilled in the art that this example is purely illustrative and that exemplary embodiments may be implemented in many types of networks other than the example provided as FIG. 2. Therein, the portion of the communication network associated with a single IP addressing zone 20 is illustrated. Other IP addressing zones (not shown) may also be supported in, e.g., their resource allocation functions, by the CLF 22 and NACF 24.

To briefly step through the exemplary network structure illustrated in FIG. 2, a number of consumer premise equipments (CPEs) 26, sometimes also referred to as “user equipments (UEs)”, are connected to the network through a digital subscriber line access multiplexer (DSLAM) 28. The DSLAMs 28 multiplex signals from the CPEs 26 together and load them onto the network via an edge collect router (ECR) 30. Communications between the end user and the network are passed between the ECR 30 and a session border controller (SBC) 32. The NACF 24 is a DHCP server from which the ECR 30 requests an IP address, via a DHCP request along with Option 82 parameters, for the associated CPE 26 which has attached to the network. This IP address is allocated from a subnet pool configured in the NACF 24. Once the IP address is allocated and returned to the ECR 30, then NACF 24 can then push this Network Attach information to the CLF 22. The SBC 32 interfaces with the rest of, for example, an IP backbone network (not shown) to, for example, interconnect a CPE 26 with another device, website, etc.

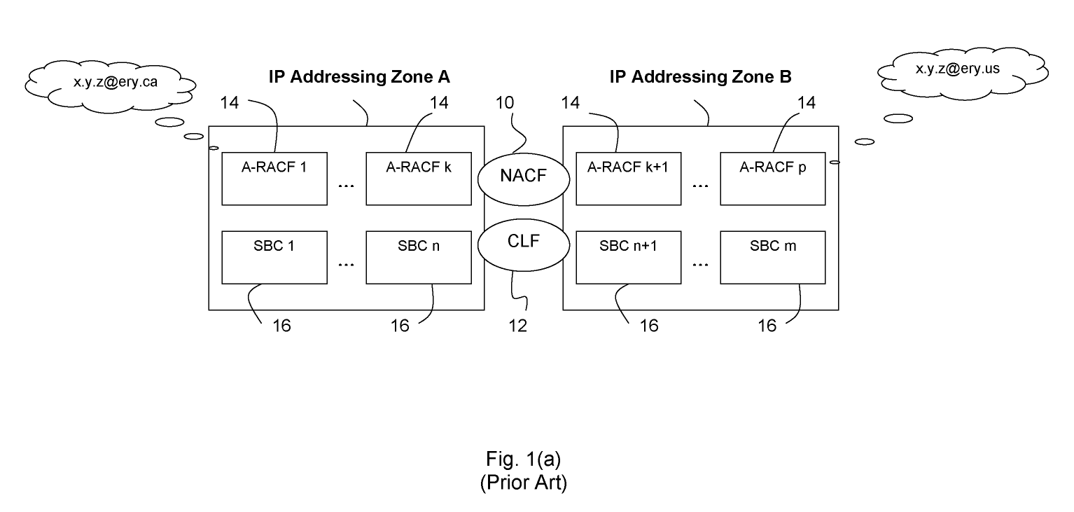

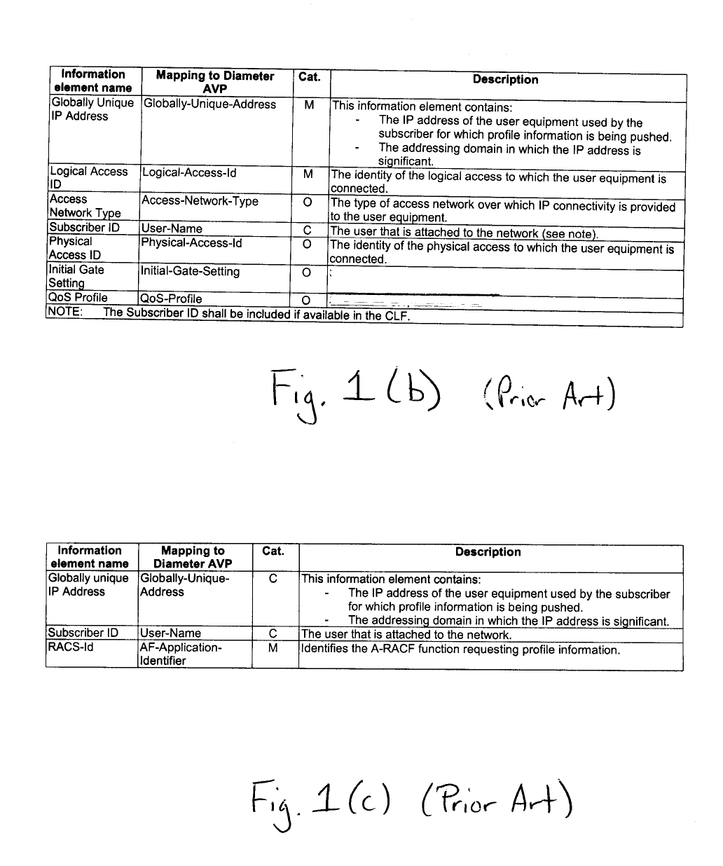

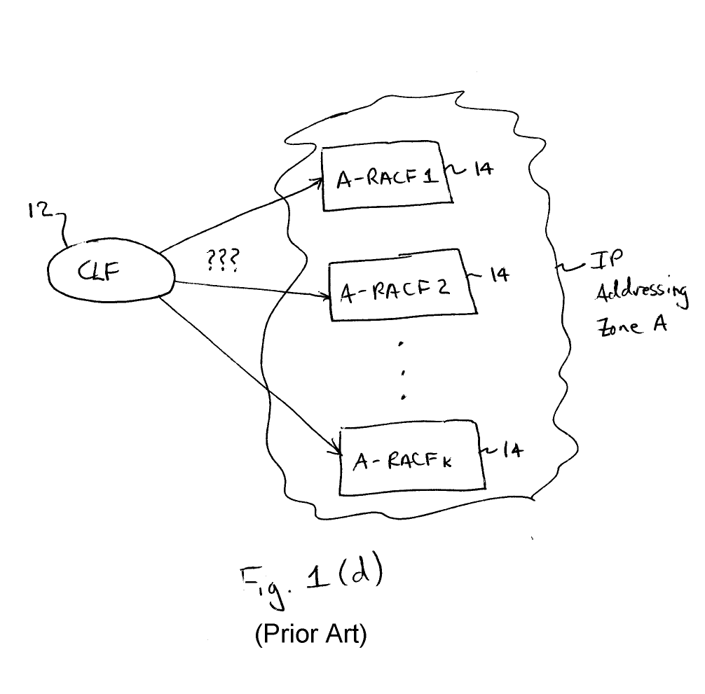

Of particular interest with respect to the present specification, it will be seen that each A-RACF 34 within the IP addressing zone 20 is assigned to its own topology zone. In this exemplary embodiment, the upper illustrated A-RACF 34 is assigned to topology zone 1 and the lower illustrated A-RACF 34 is assigned to topology zone 2. Within each IP addressing zone, each A-RACF 34 will be uniquely identifiable based on its assigned topology zone identifier. Thus, CLF 22 will be able to route access profile information associated with a CPE 26 in the upper half of the Figure to the A-RACF 34 in topology zone 1 and it will, likewise, be able to route access profile information associated with a CPE in the lower half of the Figure to the appropriate A-RACF 34 in topology zone 2. Similarly, the A-RACFs in other IP addressing zones (not shown in FIG. 2, but see FIG. 1 (a)) will be assigned to topology zones which are unique within their particular realm.

The assignment of A-RACFs 34 to topology zones as described in the above exemplary embodiment enables networks, methods and nodes according to these exemplary embodiments to correctly route access profile related information and requests to and from A-RACFs without requiring that each A-RACF be assigned to its own IP addressing zone. Thus topology zone identifiers can be provided in either or both of the access profile push and pull messages transmitted between the CLF 22 and the A-RACFs 34 as shown in Tables 1 and 2 below, respectively.

TABLE 1
Access Profile Push (CLF → A-RACF)

| | |
|---|---|
| Subscriber ID | The identity of the subscriber requesting IP |
| | connectivity. |
| Physical Access ID | The identity of the physical access to which the |
| (optional) | user equipment is connected(NOTE 1) |
| Logical Access ID | The identity of the logical access to which the |
| | user equipment is connected.(NOTE 2, 3) |
| Topology Zone | The identity of the zone this subscriber belongs |
| | to. |
| Access Network Type | The type of access network over which IP |
| | connectivity is provided to the user equipment. |
| Globally Unique IP | |
| Address | |
| Assigned IP Address | The IP address of the attached user equipment. |
| Address Realm | The addressing domain in which the IP address |
| | is significant. |
| QoS Profile Information | |
| (NOTE 4) (optional) | |
| Transport Service | The transport service class subscribed by the |
| Class | attached user. |
| UL Subscribed | The maximum amount of bandwidth subscribed |
| Bandwidth | by the attached user in the uplink direction. |
| DL Subscribed | The maximum amount of bandwidth subscribed |
| Bandwidth | by the attached user in the downlink direction. |
| Maximum priority | The maximum priority allowed for any |
| | reservation request. |
| Application class ID | Identifies the application class(−es) that are |
| | allowed for the QoS profile. |
| Initial Gate Setting | |
| (NOTE 5) (optional) | |
| List of allowed | The list of default destination IP addresses, |
| destinations | ports, prefixes and port ranges to which traffic |
| | can be sent. |
| UL Default | The maximum amount of bandwidth that can |
| Bandwidth | be used without explicit authorisation in |
| | the uplink direction. |
| DL Default | The maximum amount of bandwidth that can |
| Bandwidth | be used without explicit authorisation |
| | in the downlink direction. |

NOTE 1:
In the xDSL case, the Physical Access ID identifies the copper line.
NOTE 2:
The Logical Access ID should enable the RACS to derive the following information: the identification and bandwidth capacity of the layer 2 resources over which the subscriber traffic is carried. the address of the physical node(s) implementing the BGF, L2TF and RCEF.
NOTE 3:
In the xDSL case, the Logical Access ID may explicitly contain the identity of the port, VP and/or VC carrying the traffic.
NOTE 4:
The QoS profile may contain one or more sets of information elements.
NOTE 5:
This information is used by the RACS to configure the RCEF and/or BGF firewall functionality, before resource reservation requests are received from services/applications.

TABLE 2
Access Profile Pull (A-RACF → CLF)

Globally Unique Address
(optional) (NOTE 1)

| | |
|---|---|
| Assigned IP Address | The IP address of the attached user equipment. |
| Address Realm | The addressing domain in which the IP address |
| | is significant. |
| Subscriber ID | The identity of the attached user. |
| (optional) (NOTE 1) | |
| Topology Zone | The Topology Zone the subscriber belongs to. |

NOTE 1:
At least one of these two par meters - Subscriber ID or Global Unique IP address - shall be provided. In case more than one IP address is associated to a Subscriber ID both items need to be provided.

As mentioned above, in some alternative exemplary embodiments, it may not be necessary or desirable to transmit the topology zone identifier in both (or either of) the access profile push message and the access profile pull message as shown in the tables above. For example, in some implementations, the topology zone identifier may only be transmitted with the access profile pull message such that the CLF 22 knows to which A-RACF 34 to send a particular access profile response. Additionally, topology zones may be implemented statically or dynamically as discussed in more detail below.

Moreover, the specific formats or values used for the topology zone identifiers which are provided within these messages may vary. When provided explicitly, the topology zone identifiers can be transmitted as information elements in messages which also include the Global Unique IP identifier information element as well, as also shown in the exemplary tables above. The Global Unique IP identifier information element typically is transmitted as a value which is compliant to the Domain Name System (DNS) naming system whereas, according to one purely illustrative exemplary embodiment, the topology zone identifier will not be formatted as a DNS name.

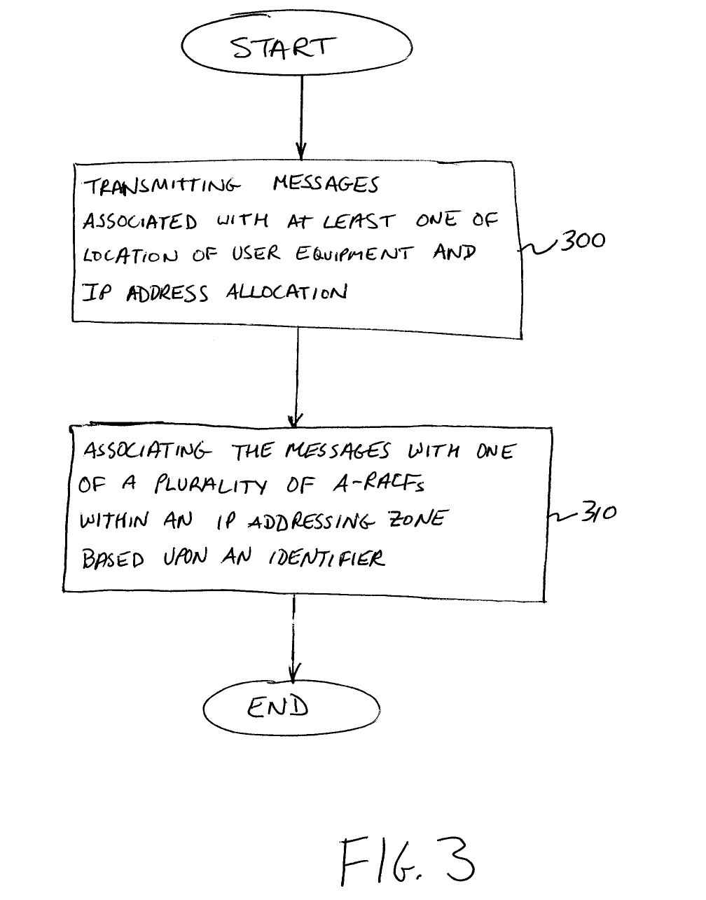

Thus, based on the foregoing, it will be appreciated that a method for communicating in a network according to an exemplary embodiment can include the steps illustrated in the flowchart of FIG. 3. Therein, messages are transmitted associated with at least one of location of user equipment and IP address allocation to the user equipment at step 300. The messages, as illustrated in step 310, are each associated with one of a number of different access resource and admission control functions (A-RACFs) within an IP addressing zone based upon an identifier, e.g., a topology zone identifier as described above. The messages may or may not include both a global IP address information element and another information element which identifies one of a plurality of access resource and admission control functions (A-RACFs), which is associated with said user equipment. According to the foregoing examples, the “another information element” can be referred to as a topology zone identifier although that particular phraseology is not required. The topology zone identifier, regardless of how it is named in a particular implementation, provides a layer of mapping between the access network and the physical resources used within an IP addressing zone which permits A-RACFs to be deployed in a manner that is logically separated from the deployment of IP addressing zones or realms, e.g., one A-RACF or multiple A-RACFs can be deployed per IP addressing zone.

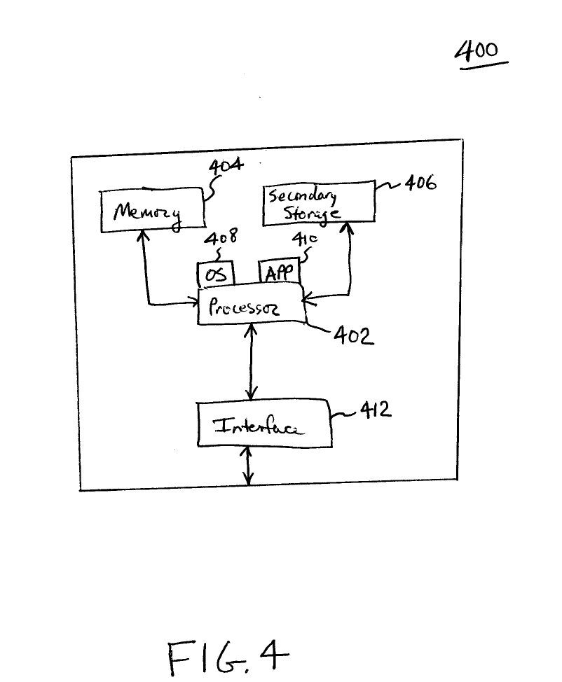

As described above, implementation of a topology zone identifier or the like according to these exemplary embodiments can impact, among other things, the CLF 22, A-RACF 34 and the SBC 32 entities within a communication network. Structurally, the CLF 22, A-RACF 34 and SBC 32 can, for example, each be implemented in hardware and software as servers. For example, as shown generally in FIG. 4, such a server 400 can include a processor 402 (or multiple processor cores), memory 404, one or more secondary storage devices 406, an operating system 408 running on the processor 404 and using the memory 404, as well as a corresponding application 410, e.g., a CLF application for the CLF server, an A-RACF application for the A-RACF server and an SBC application for the SBC server. An interface unit 412 may be provided to facilitate communications between the node 400 and the rest of the network or may be integrated into the processor 402. Thus, a network node according to an exemplary embodiment may include a processor for transmitting and receiving messages associated with at least one of location of user equipment and IP address allocation to a user equipment. The messages, e.g., an access profile push message, an access profile pull message, a subscriber location request message, etc., are associated with one of a plurality of access resource and admission control functions (A-RACFs) within an IP addressing zone based upon an identifier, e.g., a topology zone identifier.

While FIG. 4 is generic to, for example, a CLF network node, an A-RACF network node and an SBC network node, the specific messages which are transmitted and received according to these exemplary embodiments will vary by, for example, the type of node under consideration. For example, a CLF network node 400 can operate to register an association between an IP address allocated to said user equipment and network location information and can, therefore, transmit and receive messages over an e4 interface which include information associated with at least one of: initial gate setting, list of allowed destinations, uplink subscribed bandwidth, downlink subscribed bandwidth, QoS profile information, transport service class, media type, maximum priority and requestor name, among other things.

Similarly, an A-RACF network node 400 operates to verify that bandwidth needed for services requested by particular CPE 26 can be delivered and, therefore, can transmit and receive messages over an e4 interface which include information associated with at least one of: initial gate setting, list of allowed destinations, uplink subscribed bandwidth, downlink subscribed bandwidth, QoS profile information, transport service class, media type, maximum priority and requester name. Likewise, an SBC network node 400 operates as a gateway device between the end user and the network and can transmit and receive messages including information associated with a location information query for, e.g., 911 purposes. In response to this query, the CLF 22 can provide the SBC 32 with the topology zone of the appropriate A-RACF 34 from which it can request a reservation.

As mentioned earlier, the assignment of topology zones according to exemplary embodiments may be static or dynamic. For example, a CLF 22 can have a list stored in its memory of entities which are permitted to connect thereto, which list may include, among other attributes, a statically configured topology zone assignment based on IP address ranges. Alternatively, when an A-RACF 34 communicates with the CLF 22, the message can indicate its intrinsic knowledge that it is permitted to connect to that particular CLF 22 along with the provision of a dynamically assigned topology zone identifier. In part, implementation of static or dynamic topology zone assignment may depend upon how a network is deployed. For example, although the illustrative example of FIG. 2 portrays a one-to-one relationship between SBCs 32 and A-RACFs 34, other exemplary embodiments may have many SBCs 32 for each A-RACF 34 or vice versa.

Although profile access push and pulls are described above as examples of messages which may include, or be affected by, topology zone identifiers according to exemplary embodiments, those skilled in the art will appreciate that other messages may also include, or be affected by, topology zone identifiers. For example, IP release indications are used by the NASS to report loss of IP connectivity. To report this information, the CLF 22 can send a message to the appropriate A-RACF 32 based upon its knowledge of the appropriate topology zone. The message, an example of which is provided in Table 3 below, may also include the topology zone identifier.

TABLE 3
IP Connectivity Release Indication (CLF → A-RACF)

Globally Unique Address

| | |
|---|---|
| Assigned IP Address | The IP address of the attached user equipment. |
| Address Realm | The addressing domain in which the IP address |
| | is significant. |
| Subscriber ID | The identity of the attached user |
| (optional) | |
| Topology Zone | The Topology Zone the subscriber belongs to. |

The foregoing description of exemplary embodiments provides illustration and description, but it is not intended to be exhaustive or to limit the invention to the precise form disclosed. For example, topology zones and the like as described above with respect to the exemplary embodiments can adapt and be added, e.g., for scalability reasons. Modifications and variations are possible in light of the above teachings or may be acquired from practice of the invention. The following claims and their equivalents define the scope of the invention.

1. A network node comprising:
a processor for transmitting and receiving messages associated with at least one of: a location of user equipment and an IP address allocation to said user equipment,
wherein said messages are associated with one of a plurality of access resource and admission control functions (A-RACFs) within an IP addressing zone based upon an identifier,
wherein said one of said plurality of A-RACFs is associated with said user equipment.

2. The network node of claim 1, wherein said messages include both a global IP address information element and another information element containing said identifier which identifies said one of said plurality of A-RACFs.

3. The network node of claim 1, wherein said identifier is a topology zone identifier.

4. The network node of claim 1, wherein said network node supports a connectivity session location function (CLF) to register an association between an IP address allocated to said user equipment and network location information, and
further wherein said processor transmits messages over an e4 interface, said messages including information associated with at least one of: initial gate setting, list of allowed destinations, uplink subscribed bandwidth, downlink subscribed bandwidth, QoS profile information, transport service class, media type, maximum priority and requester name.

5. The network node of claim 4, wherein said processor transmits said messages in response to an access profile pull request from one of said plurality of A-RACFs.

6. The network node of claim 4, wherein said processor transmits said messages when an IP address has been allocated to said user equipment.

7. The network node of claim 1, wherein said network node supports one of said plurality of access resource and admission control functions (A-RACFs) to verify that bandwidth needed for requested services can be delivered over physical resources modeled in said one of said A-RACFs, further wherein said processor receives messages over an e4 interface, said messages including information associated with at least one of: initial gate setting, list of allowed destinations, uplink subscribed bandwidth, downlink subscribed bandwidth, QoS profile information, transport service class, media type, maximum priority and requester name.

8. The network node of claim 7, wherein said processor receives said messages in response to its own transmission of a corresponding access profile pull request.

9. The network node of claim 1, wherein said network node supports a session border control (SBC) function and further wherein said messages include a location information query and a response to a location information query.

10. The network node of claim 1, wherein said network node is a server including said processor, memory, at least one secondary storage device, an operating system and an application running thereon.

11. A method for communicating in a network:
transmitting messages associated with at least one of: location of user equipment and IP address allocation for said user equipment,
wherein said messages are associated with one of a plurality of access resource and admission control functions (A-RACFs) within an IP addressing zone based upon an identifier,
wherein said one of said plurality of A-RACFs is associated with said user equipment.

12. The method of claim 11, wherein said messages include both a global IP address information element and another information element which identifies one of a plurality of access resource and admission control functions (A-RACFs) which is associated with said user equipment.

13. The method of claim 11, wherein said identifier is a topology zone identifier.

14. The method of claim 11, further comprising:
supporting a connectivity session location function (CLF) to register an association between an IP address allocated to said user equipment and network location information, and
further wherein said messages are transmitted over an e4 interface, said messages including information associated with at least one of: initial gate setting, list of allowed destinations, uplink subscribed bandwidth, downlink subscribed bandwidth, QoS profile information, transport service class, media type, maximum priority and requestor name.

15. The method of claim 14, wherein said messages are transmitted in response to an access profile pull request from one of said plurality of A-RACFs.

16. The method of claim 14, wherein said messages are transmitted when an IP address has been allocated to said user equipment.

17. The method of claim 11, further comprising:
supporting one of said plurality of access resource and admission control functions (A-RACFs) to verify that bandwidth needed for requested services can be delivered over physical resources modeled in said one of said A-RACFs, and
further wherein said messages are received over an e4 interface, said messages including information associated with at least one of: initial gate setting, list of allowed destinations, uplink subscribed bandwidth, downlink subscribed bandwidth, QoS profile information, transport service class, media type, maximum priority and requester name.

18. The method of claim 17, wherein said messages are received in response to transmission of a corresponding access profile pull request.

19. The method of claim 11, wherein said network node supports a session border control (SBC) function include a location information query and a response to a location information query.

20. A communication network comprising:
a first server which provides a connectivity session location function (CLF) to register an association between an IP address allocated to a user equipment and network location information, and
a plurality of second servers, each of which provides an access resource and admission control function (A-RACF) to verify that bandwidth needed for requested services can be delivered, said plurality of second servers each being associated with a single IP addressing zone;
wherein each of said second servers is associated with a different topology zone identifier and
further wherein at least some messages transmitted between said first server and said second servers includes both a global IP address information element and one of said topology zone identifiers.
